(19) United States
(12) Patent Application Publication
(10) Pub. No.: US 2018/0321721 A1
(43) Pub. Date: Nov. 8, 2018

(54) INFORMATION PROCESSING APPARATUS AND METHOD FOR CONTROLLING THE SAME, AND CABLE

(71) Applicant: SONY CORPORATION, TOKYO (JP)

(72) Inventor: SATOSHI TERAMOTO, SAITAMA (JP)

(21) Appl. No.: 15/772,731

(22) PCT Filed: Oct. 3, 2016
(86) PCT No.: PCT/JP2016/079356

§ 371 Date: May 1, 2018

(30) Foreign Application Priority Data
Nov. 17, 2015 (JP) 2015-225173

(51) Int. Cl. G06F 1/26

(52) U.S. Cl. CPC G06F 1/26; H04N 21/43635

(57) ABSTRACT

To provide an information processing apparatus that performs electric power supply to a cable-connected device. A transmission cable 30 includes an ID device 34 that stores information that identifies high-power electricity supply information, etc. A reception section 21 on the side of a sink device 20 can read, from the ID device 34 via a cable detection signal line 35, high-power electricity supply information of the transmission cable 30. The cable detection signal line 35 is inputted and outputted between the sink device 20 and the transmission cable 30 using a reserved pin in an existing MHL standard. Further, the cable detection signal line 35 is C-cut in each of the sink device 20 and the cable 30.

### TECHNICAL FIELD

A technology disclosed in the present specification relates to an information processing apparatus that performs data transmission in conformity with a prescribed communication interface standard and a method for controlling the same, and a cable; for example, relates to an information processing apparatus that performs the transmission of signals of a video image and a sound by being connected to another device via a cable conforming to Mobile High-Definition Link (MHL) and a method for controlling the same, and a cable.

### BACKGROUND ART

These days, mobile devices capable of displaying high definition video images, such as smartphones and tablets, are coming into wide use. Accordingly, the development of MHL, which is a communication interface standard for mobile devices for transmitting video images at high speed, is being advanced (for example, see Patent Literature 1).

Communication interface standards that achieve digital video image transmission include also High Definition Multimedia Interface (HDMI) (registered trademark). In contrast, main features of MHL are minimizing the mounting area as a minimum pin configuration necessary for video image transmission and supporting electric power supply.

MHL devices are classified into categories of a source device that transmits a video signal, a sink device that receives and displays a video signal, and a dongle device that converts a video signal of an MHL system to another video signal. Then, an MHL cable that satisfies an MHL standard is used for connection and signal transmission between MHL devices. Examples of the source device include a personal computer, a smartphone, a tablet terminal, a game device, a digital camera, and the like. Further, examples of the sink device include a display device such as a digital TV. By connecting a source device and a sink device by means of one MHL cable, a high definition video image can be transmitted, and furthermore the supply of electric power (the charging of the source device) can be performed. In the MHL standard, basically it is supposed that a video signal is transmitted in one direction from the source device to the sink device.

### CITATION LIST

### Patent Literature

Patent Literature 1: JP 2012-169702A

### DISCLOSURE OF INVENTION

### Technical Problem

An object of a technology disclosed in the present specification is to provide an excellent information processing apparatus that can perform electric power supply favorably with an opposite communication side that is cable-connected in conformity with a prescribed communication interface standard and a method for controlling the same, and a cable.

### Solution to Problem

A technology disclosed in the present specification has been made in view of the above problem, and a first aspect thereof is an information processing apparatus including: a communication section configured to communicate with another device via a cable; a detection section configured to detect information regarding electricity supply of the cable; and a control section configured to control electric power supply to the other device via the cable on a basis of a result of detection by the detection section.

According to a second aspect of the technology disclosed in the present specification, in the information processing apparatus according to the first aspect, the detection section detects the information regarding the electricity supply of the cable from an ID device included in the cable.

According to a third aspect of the technology disclosed in the present specification, in the information processing apparatus according to the second aspect, the detection section detects information of the ID device via a cable detection signal line that is DC-cut.

According to a fourth aspect of the technology disclosed in the present specification, in the information processing apparatus according to the second aspect, the communication section communicates with the other device via the cable conforming to a prescribed communication interface standard, and the detection section detects information of the ID device via a cable detection signal line allocated to a reserved pin in the prescribed communication interface standard.

According to a fifth aspect of the technology disclosed in the present specification, in the information processing apparatus according to the first aspect, the control section controls electric power supply to the other device via the cable in accordance with an electricity supply request from the other device.

According to a sixth aspect of the technology disclosed in the present specification, in the information processing apparatus according to the fifth aspect, the control section determines whether or not electric power requested by the other device is able to be transmitted with a rated current or a rated voltage of the cable detected by the detection section.

According to a seventh aspect of the technology disclosed in the present specification, in the information processing apparatus according to the fifth aspect, the control section notifies the other device that electric power requested by the other device is unable to be transmitted via the cable.

According to an eighth aspect of the technology disclosed in the present specification, in the information processing apparatus according to the fifth aspect, the control section notifies the other device that electric power requested by the other device is unable to be outputted from the information processing apparatus.

According to a ninth aspect of the technology disclosed in the present specification, in the information processing apparatus according to the seventh or eighth aspect, the control section displays, on a display section, a fact that the electric power requested by the other device is unable to be supplied.

According to a tenth aspect of the technology disclosed in the present specification, in the information processing apparatus according to the first aspect, the communication section communicates with the other device via the cable conforming to a prescribed communication interface standard, and the control section controls electric power supply to the other device in accordance with a version of the prescribed communication interface standard that the other device and the cable conform to.

According to an eleventh aspect of the technology disclosed in the present specification, in the information processing apparatus according to the tenth aspect, the control section notifies the other device that electric power requested by the other device is unable to be transmitted with the version that the cable conforms to.

According to a twelfth aspect of the technology disclosed in the present specification, in the information processing apparatus according to the fourth or tenth aspect, the prescribed communication interface standard is a superMHL standard.

In addition, a thirteenth aspect of the technology disclosed in the present specification is a method for controlling an information processing apparatus, the information processing apparatus being configured to communicate with another device via a cable, the method including: a detection step of detecting information regarding electricity supply of the cable; and a control step of controlling electric power supply to the other device via the cable on a basis of a result of detection in the detection step.

In addition, a fourteenth aspect of the technology disclosed in the present specification is a cable including: a first connection section to be connected to a first device configured to transmit information; a second connection section to be connected to a second device configured to receive the information; and an ID device capable of reading, from the second connection section, information regarding electricity supply.

According to a fifteenth aspect of the technology disclosed in the present specification, in the cable according to the fourteenth aspect, the ID device is capable of performing reading from the second connection section via a cable detection signal line that is DC-cut.

According to a sixteenth aspect of the technology disclosed in the present specification, in the cable according to the fourteenth aspect, the second connection section is to be connected to the second device conforming to a prescribed communication interface standard, and the cable signal line is allocated to a reserved pin in the prescribed communication interface standard.

According to a seventeenth aspect of the technology disclosed in the present specification, in the cable according to the fourteenth aspect, the ID device retains information regarding a rated current or a rated voltage transmittable with the cable.

According to an eighteenth aspect of the technology disclosed in the present specification, in the cable according to the fourteenth aspect, the ID device retains a coded value indicating a combination of a rated current and a rated voltage transmittable with the cable.

According to a nineteenth aspect of the technology disclosed in the present specification, the cable according to the fourteenth aspect further includes: a second ID device capable of reading, from the first connection section, the information regarding electricity supply.

According to a twentieth aspect of the technology disclosed in the present specification, in the cable according to the sixteenth aspect, the prescribed communication interface standard is a superMHL standard.

### Advantageous Effects of Invention

According to a technology disclosed in the present specification, an excellent information processing apparatus that can perform electric power supply favorably with an opposite communication side that is cable-connected in conformity with a prescribed communication interface standard and a method for controlling the same, and a cable can be provided.

Note that the advantageous effects described in this specification are merely for the sake of example, and the advantageous effects of the present invention are not limited thereto. Furthermore, in some cases the present invention may also exhibit additional advantageous effects other than the advantageous effects given above.

Further objectives, features, and advantages of the technology disclosed in this specification will be clarified by a more detailed description based on the exemplary embodiments discussed hereinafter and the attached drawings.

### BRIEF DESCRIPTION OF DRAWINGS

FIG. 1 is a diagram schematically showing a basic configuration of a communication system 1.

FIG. 2 is a diagram showing a configurational example of the communication system 1 adapted to high-power electricity supply.

FIG. 3 is a diagram showing another configurational example of the communication system 1 adapted to high-power electricity supply.

FIG. 4 is a diagram showing a configurational example of a communication system including a source device, a sink device, and a cable not adapted to high-power electricity supply.

FIG. 5 is a diagram showing a configurational example of a communication system in which a cable not adapted to high-power electricity supply is joined to a sink device 20 adapted to high-power electricity supply.

FIG. 6 is a diagram showing another configurational example of the communication system 1 adapted to high-power electricity supply.

FIG. 7 is a diagram showing a configurational example of a communication system in which a cable 30 adapted to high-power electricity supply is joined to a sink device not adapted to high-power electricity supply.

FIG. 8 is a flow chart showing a processing procedure for starting electric power supply from a sink device to a source device.

### MODE(S) FOR CARRYING OUT THE INVENTION

Hereinafter, an embodiment of the technology disclosed in the present specification will be described in detail with reference to the drawings.

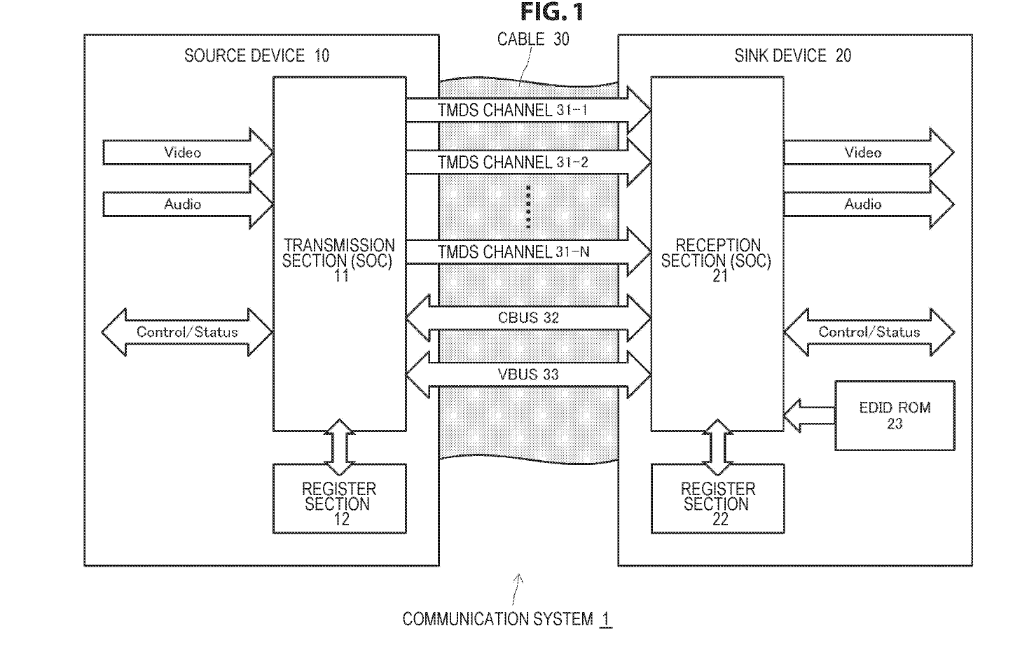

FIG. 1 schematically shows a basic configuration of a communication system 1 in which a video image and a sound are transmitted. The communication system 1 includes a combination of a source device 10 and a sink device 20. The source device 10 is a supplier of video information and audio information, and is supposed to be a mobile device such as a smartphone. Further, the sink device 20 is an output destination of video information and audio information, and is supposed to be a stationary device having a large screen such as a television.

The source device 10 includes a transmission section 11, the sink device 20 includes a reception section 21, and the transmission section 11 and the reception section 21 are connected together by, for example, a cable 30 conforming to a prescribed communication interface standard such as MHL.

The cable 30 includes N transition-minimized differential signaling (TMDS) channels 31-1, . . . , and 31-N, a control bus (CBUS) or eCBUS 32, and a voltage bus (VBUS) 33.

Each of the TMDS channels 31-1, . . . , and 31-N is a differential pair line used mainly to transmit moving video information and audio information. One TMDS channel is referred to as a “lane.” In this regard, one lane is prescribed in versions 1 to 3 of MHL, but in the example shown in FIG. 1 it is supposed that the source device 10 and the sink device 20 are connected together by a plurality of lanes (N lanes). By increasing the number of lanes, it becomes possible to transmit a video signal in a higher bandwidth and with a higher resolution. Note that TMDS is a transmission system of a digital video signal that is standardized by Video Electronics Standards Association (VESA), a detailed description of which is omitted.

The CBUS 32 is a bidirectional data bus used for communication mainly for the control of video image and sound transmission, device cooperation, etc. The CBUS 32 is referred to as CBUS in versions 1 to 2 of MHL and as eCBUS in version 3 and subsequent versions, and is hereinafter collectively referred to as “CBUS.” In the present embodiment, it is supposed that the transfer of control information regarding electricity supply between the source device 10 and the sink device 20 is performed using the CBUS 32.

The V (voltage) BUS 33 is an electric power supply line used mainly for electric power supply. Electric power is supplied basically in the direction from the sink device 20, such as a television to which a commercial power source is connected, to the source device 10 that is battery-driven, such as a smartphone. On the source device 10 side, the driving of itself and the charging of a built-in battery (not illustrated) can be performed by electric power supplied via the VBUS 33. In the present embodiment, it is supposed that a high-power electricity supply of approximately several tens of watts to 100 watts is performed via the VBUS 33.

Video information (Video) and audio information (Audio) reproduced by a not-illustrated information reproduction section are supplied to the transmission section 11 on the source device 10 side. Then, the transmission section 11 transmits the moving video information and the audio information using one lane or two or more lanes among the TMDS channels 31-1, . . . , and 31-N in the cable 30. It is assumed that the transmission section 11 includes, for example, a system-on-a-chip (SOC), and performs also the processing of requesting electricity supply (high-power electricity supply) to the sink device 20.

Information regarding the source device 10 is retained in a register section 12. The information retained in the register section 12 includes also electricity supply information that the source device 10 requests to the sink device 20. It is assumed that the sink device 20 can read information in the register section 12 via the transmission section 11.

On the other hand, if the reception section 21 on the sink device 20 side receives moving video information and audio information that are transmitted using one lane or two or more lanes among the TMDS channels 31-1, . . . , and 31-N in the cable 30, the reception section 21 performs screen displaying and sound outputting with a not-illustrated information output section. It is assumed that the reception section 21 includes, for example, an SOC, and performs also control for performing electricity supply (high-power electricity supply) to the source device 10.

Information regarding the sink device 20 is retained in a register section 22. The information retained in the register section 22 includes also electricity supply information that the sink device 20 can supply to the source device 10. It is assumed that the source device 10 can read information in the register section 22 via the reception section 21.

An Extended Display Identification Data (EDID) ROM 23 includes, for example, an electrically erasable and programmable ROM (EEPROM), and stores information regarding display performance (the resolution, the refresh rate, etc.) in the sink device 20.

As described above, electric power is supplied from the sink device 20 to the source device 10 via the VBUS 33, and the driving of the source device 10 and the charging of a built-in battery (not illustrated) can be performed by the supplied electric power of the source device 10 box.

In an existing (or widely spread at the time of the present application) MHL system, an electricity supply limited to approximately several watts (for example, 4.5 watts) is performed, but it is feared that electric power will be insufficient depending on the use. In contrast, in a next-time MHL system, expanding the supplied electric power up to several tens of watts or more (for example, set to 100 watts) is proposed.

High-power electricity supply can be achieved by using a source device, a sink device, and a cable conforming to the next-time MHL standard. However, a source device and a sink device conforming only to the existing MHL standard cannot determine whether or not the opposite connection side and a cable used for connection are adapted to high-power electricity supply. Further, in a case where a device conforming to the next-time MHL standard is joined to a device or a cable that conforms only to the existing MHL standard and does not have the capability of high-power electricity supply, there are risks of smoke emission and fire catching due to an overcurrent or the like.

Thus, in the present specification, a description will now be given on a communication system 1 that determines whether or not each of a source device, a sink device, and a cable is adapted to high-power electricity supply and can perform high-power electricity supply on the basis of the determination result.

Note that it is supposed that superMHL 1.X is taken as the existing MHL standard, and superMHL 2.X or a subsequent version is taken as the next-time MHL system.

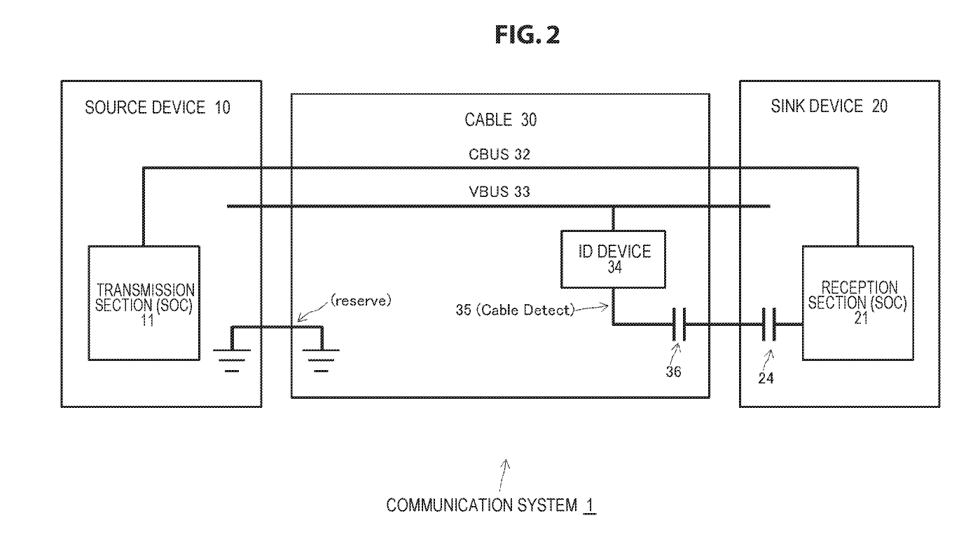

FIG. 2 shows a configurational example in which a portion mainly related to high-power electricity supply of the communication system 1 shown in FIG. 1 is extracted. In the drawing, it is assumed that all of the source device 10, the sink device 20, and the cable 30 conform to the next-time MHL standard, and are adapted to high-power electricity supply.

The transmission section 11 on the source device 10 side and the reception section 21 on the sink device 20 side can perform bidirectional communication of control data using the CBUS 32 included in the cable 30, and can perform the supply of electric power (high-power electricity supply) from the sink device 20 to the source device 10 using the VBUS 33.

It is assumed that the source device 10 and the sink device 20 can exchange, via the CBUS 32, information such as high-power electricity supply information of the other side (that is, a current value and a voltage value that the source device 10 requests, and a current value and a voltage value that the sink device 20 can supply).

Further, the cable 30 includes an ID device 34 that stores information that identifies high-power electricity supply information (that is, a current value and a voltage value transmittable via the VBUS 33), etc.

The reception section 21 on the sink device 20 side can read high-power electricity supply information of the cable 30 from the ID device 34 via a cable detection signal line (Cable Detect) 35. Further, the sink device 20 can transmit high-power electricity supply information of the cable 30 to the transmission section 11 of the source device 10 via the CBUS 32.

In the present example, it is supposed that the cable detection signal line 35 is allocated to a reserved pin (reserve) in the existing MHL standard, and high-power electricity supply information is inputted and outputted between the sink device 20 and the cable 30. This reserved pin is grounded in a cable, a source device, and a sink device conforming to the existing MHL standard (described later).

The source device 10 does not read high-power electricity supply information from the cable 30; hence, in the cable 30, the ID device 34 is provided only on one side that is joined to the sink device 20. Further, a reserved pin is grounded in both the cable 30 and the source device 10. In other words, in the configurational example shown in FIG. 2, the cable 30 has directivity, and it is necessary that one end portion from which the cable detection signal line 35 is outputted be joined to the sink device 20 side (or the side of a device that supplies electric power), and the source device 10 (or the side of a device to which electric power is supplied) be joined to the other end portion. Further, it is sufficient that the ID device 34 be provided only on one side of the cable 30.

It is also supposed that a cable conforming to the existing MHL standard (not equipped with the ID device 34) is joined to the sink device 20 conforming to the next-time MHL standard shown in FIG. 2. In such a case, the signal line is DC-cut on the sink device 20 side by a capacitor or the like as shown by reference numeral 24 in order to avoid a situation where the cable detection signal line 35 is directly grounded on the cable side and the circuit of the reception section 21 is damaged.

Further, it is also supposed that a sink device conforming to the existing MHL standard (not performing reading from the ID device 34) is joined to the cable 30 conforming to the next-time MHL standard shown in FIG. 2. In such a case, the signal line is DC-cut also on the cable 30 side by a capacitor or the like as shown by reference numeral 36 in order to avoid a situation where the cable detection signal line 35 is directly grounded on the sink device side and the circuit of the ID device 34 is damaged.

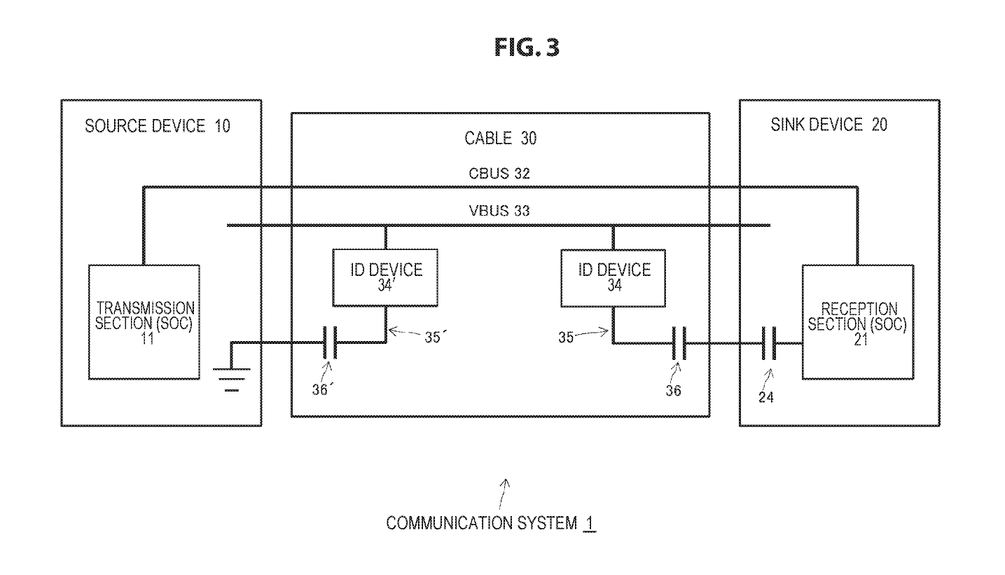

FIG. 3 shows a modification example of the communication system 1 adapted to high-power electricity supply shown in FIG. 2. In the system configuration shown in FIG. 2, the cable 30 has directivity (described above), and hence it is necessary that the sink device 20 be joined to one end portion from which the cable detection signal line 35 is outputted and the source device 10 be joined to the other end portion. In contrast, in the system configuration shown in FIG. 3, ID devices 34 and 34′ are provided in the cable 30, and cable detection signal lines 35 and 35′ are outputted from both end portions of the cable 30; thus, the sink device 20 may be connected to either end portion. That is, the cable 30 does not have directivity in the example shown in FIG. 3.

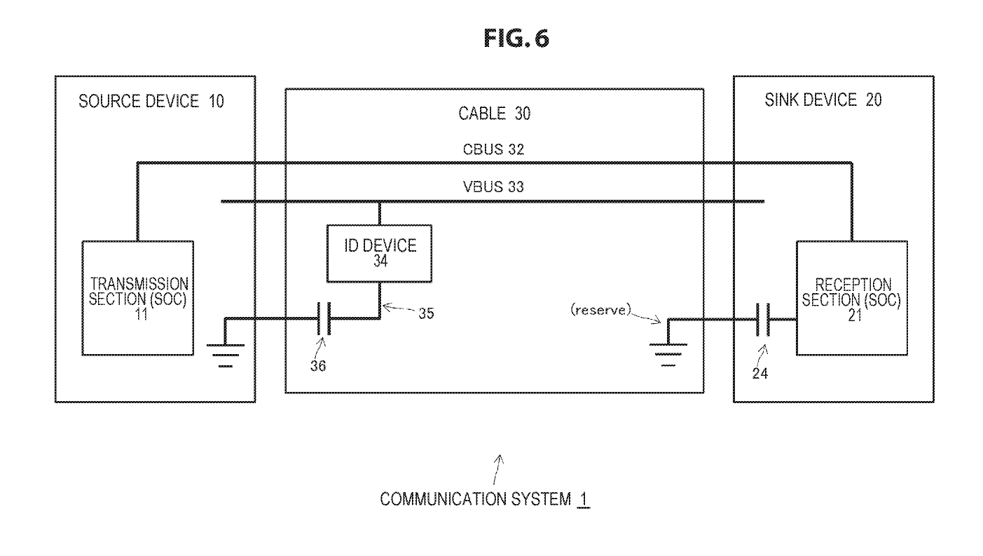

Note that, in a case where the cable 30 shown in FIG. 2 (having directivity) is set in the opposite direction and the source device 10 and the sink device 20 are joined (see FIG. 6), the sink device 20 cannot access the ID device 34 in the cable 30, and therefore recognizes that the cable 30 is not adapted to high-power electricity supply. However, since the cable detection signal line is DC-cut on the sink device 20 side by a capacitor or the like as shown by reference numeral 24, the circuit of the reception section 21 is prevented from being damaged even if the reserved pin is grounded on the cable 30 side.

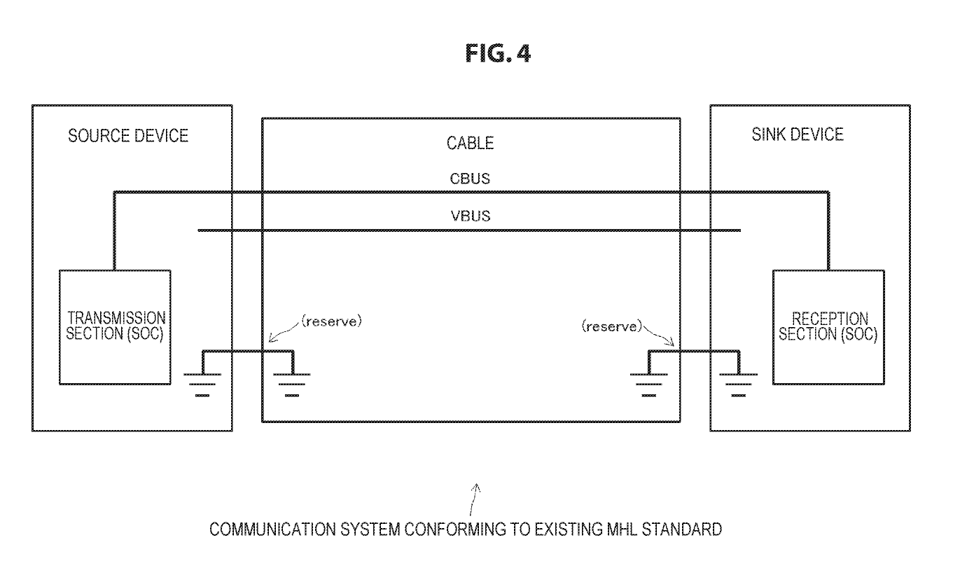

FIG. 4 shows, as a contrast to the communication systems 1 shown in FIG. 2 and FIG. 3, a configurational example of a communication system that includes a source device, a sink device, and a cable conforming to the existing MHL standard (that is, not adapted to high-power electricity supply).

A transmission section on the source device side and a reception section on the sink device side can perform bidirectional communication of control data using a CBUS included in the cable, and can perform the supply of normal electric power from the sink device to the source device using a VBUS. However, the cable is not equipped with an ID device. Further, a reserved pin is grounded in each of the source device, the sink device, and the cable.

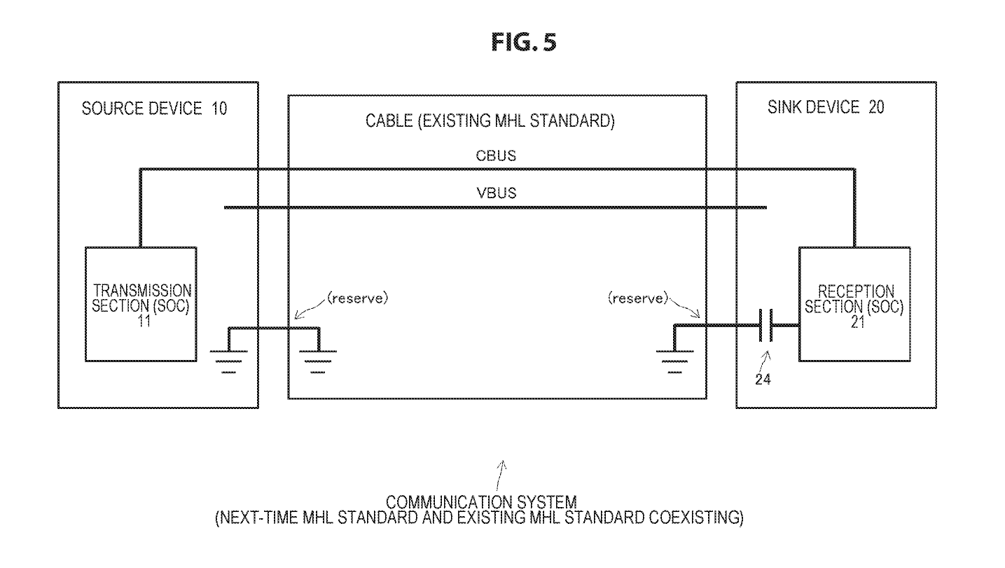

Further, FIG. 5 shows, as a contrast to the communication system 1 shown in FIG. 2, a configurational example of a communication system in which a cable conforming to the existing MHL standard (that is, not adapted to high-power electricity supply) is joined to the sink device 20 conforming to the next-time MHL standard (that is, adapted to high-power electricity supply). Note that the source device may be either adapted or not adapted to high-power electricity supply.

The reception section 21 on the sink device 20 side can perform bidirectional communication of control data with a transmission section on the source device side using a CBUS included in the cable. Further, the reception section 21 on the sink device 20 side can perform the supply of normal electric power to the source device using a VBUS.

The cable shown in FIG. 5 does not include an ID device, and hence reserved pins are grounded in the cable. On the other hand, since the cable detection signal line is DC-cut on the sink device 20 side by a capacitor or the like as shown by reference numeral 24, the circuit of the reception section 21 is prevented from being damaged even if the reserved pin is grounded on the cable side. Further, since the cable does not include an ID device and cannot read high-power electricity supply information, the sink device 20 can recognize that the cable is not adapted to high-power electricity supply.

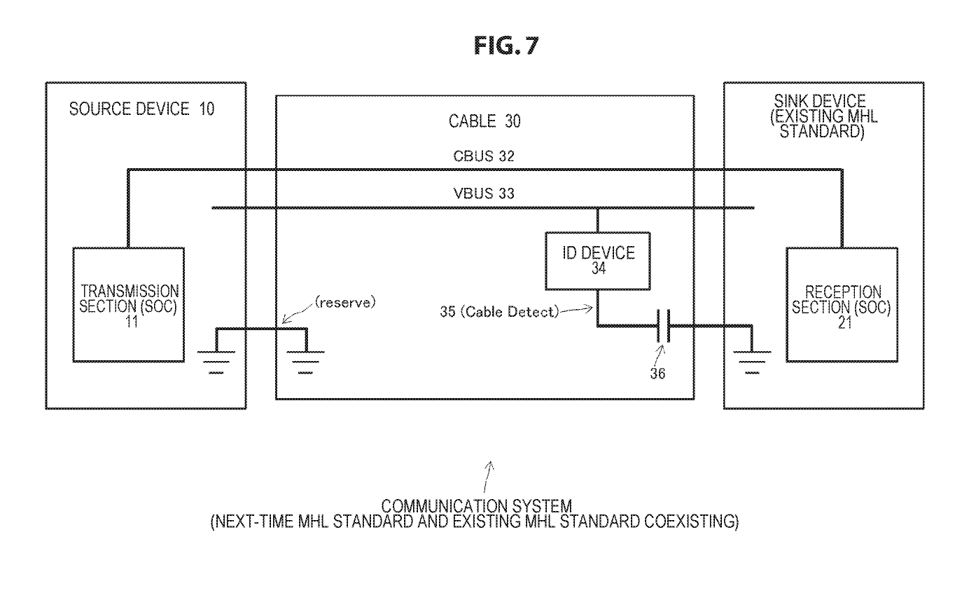

Further, FIG. 7 shows, as a contrast to the communication system 1 shown in FIG. 2, a configurational example of a communication system in which the cable 30 conforming to the next-time MHL standard (that is, adapted to high-power electricity supply) is joined to a sink device conforming to the existing MHL standard (that is, not adapted to high-power electricity supply). Note that the source device is supposed to be either adapted or not adapted to high-power electricity supply.

The reception section on the sink device side can perform bidirectional communication of control data with the transmission section on the source device side using the CBUS 32 included in the cable 30. Further, the reception section on the sink device side can perform the supply of normal electric power to the source device using the VBUS 33.

The cable 30 conforming to the next-time MHL standard is equipped with the ID device 34, and a reserved pin is allocated to the cable detection signal line 35 for reading high-power electricity supply information from the ID device 34. On the other hand, the reserved pin is grounded on the side of the sink device conforming to the existing MHL standard. In the cable 30, the cable detection signal line 35 is connected to the reserved pin after being DC-cut by a capacitor or the like as shown by reference numeral 36, and the ID device 34 is not directly grounded; thus, the circuit is prevented from being damaged.

In short, in the configuration of the communication system 1 shown in FIG. 2 (and FIG. 3), the sink device 20 can determine whether or not a cable attached to itself or a source device connected via a cable is adapted to high-power electricity supply; thus, there is no problem in terms of the system (for example, there is no risk that an overcurrent or the like will be supplied and smoke emission or fire catching will be caused), and perfect downward compatibility is ensured.

Table 1 shows an example of the data configuration of high-power electricity supply information stored in the ID device 34 of the cable 30.

TABLE 1

| | 5 V | 9 V | 12 V | 20 V |
|---|---|---|---|---|
| 0.9 A | 4.5 W | 8.1 W | 10.8 W | 18 W |
| 3 A | 15 W | 27 W | 36 W | 60 W |
| 5 A | 25 W | 45 W | 60 W | 100 W |

The row of Table 1 above shows the rated current, and the column shows the rated voltage; and each section describes the supplied electric power corresponding to the rated current and the rated voltage. For example, if the rated current and the rated voltage show 3 A and 12 V, respectively, in the ID device 34 of the cable 30, then the electric power that the cable 30 can transmit via the VBUS 33 is 36 W.

Further, Table 2 shows another example of the data configuration of high-power electricity supply information stored in the ID device 34 of the cable 30. Instead of showing the rated values of current and voltage as in Table 1, Table 2 shows the transmittable electric power value as a coded value (in the table, the serial numbers, which are arranged in ascending order of the electric power values, are taken as coded values).

TABLE 2

| | 5 V | 9 V | 12 V | 20 V |
|---|---|---|---|---|
| 0.9 A | #1 | #2 | #3 | #5 |
| 3 A | #4 | #7 | #8 | #10 |
| 5 A | #6 | #9 | #11 | #12 |

For example, in a case where the cable 30 can transmit an electric power with a rated current and a rated voltage of 3 A and 12 V, respectively, the corresponding coded value “#8” is stored in the ID device 34 in the cable 30.

Further, the sink device 20 and the source device 10 may similarly show the suppliable electric power and the necessary electric power, respectively, as coded values like those shown in Table 2.

Even with a simple term of a “communication system conforming to the MHL standard,” it is supposed that each of the source device, the cable, and the sink device conforms to either the existing MHL standard or the next-time MHL standard. Source devices, cables, and sink devices conforming to the existing MHL standard are not adapted to high-power electricity supply but adapted only to normal electricity supply. Further, source devices, cables, and sink devices conforming to the next-time MHL standard are adapted to normal electricity supply without exception; but there are cases where such devices and cables are adapted to high-power electricity supply and cases where such devices and cables are not adapted to high-power electricity supply. Thus, the communication system is adapted to normal electricity supply as a whole without exception; on the other hand, for high-power electricity supply, classification is made into the case of being capable of supporting high-power electricity supply, the case of being incapable of supporting high-power electricity supply (due to an insufficient output of the sink device or the cable), and the case where high-power electricity supply is unnecessary (because the source device does not request high-power electricity supply). Corresponding relationships between combinations of standards that the source device, the cable, and the sink device conform to and high-power electricity supply are collectively shown in Table 3 below. Further, case numbers of the cases are assigned in the rightmost column of Table 3.

TABLE 3

| | | | Electricity supply | | |
|---|---|---|---|---|---|
| Standard | | | Normal | High-power | |
| Source | | Sink | electricity | electricity | |
| device | Cable | device | supply | supply | No. |
| Next-time | Next-time | Next-time | Possible | Possible | 1a |
| MHL | MHL | MHL | Possible | Unnecessary | 1b |
| | | | Possible | Impossible | 1c |
| | | Existing | Possible | Impossible | 2 |
| | | MHL | | | |
| | Existing | Next-time | Possible | Impossible | 3 |
| | MHL | MHL | | | |
| | | Existing | Possible | Impossible | 4 |
| | | MHL | | | |
| Existing | Next-time | Next-time | Possible | Impossible | 5 |
| MHL | MHL | MHL | | | |
| | | Existing | Possible | Impossible | 6 |
| | | MHL | | | |
| | Existing | Next-time | Possible | Impossible | 7 |
| | | MHL | | | |
| | MHL | Existing | Possible | Impossible | 8 |
| | | MHL | | | |

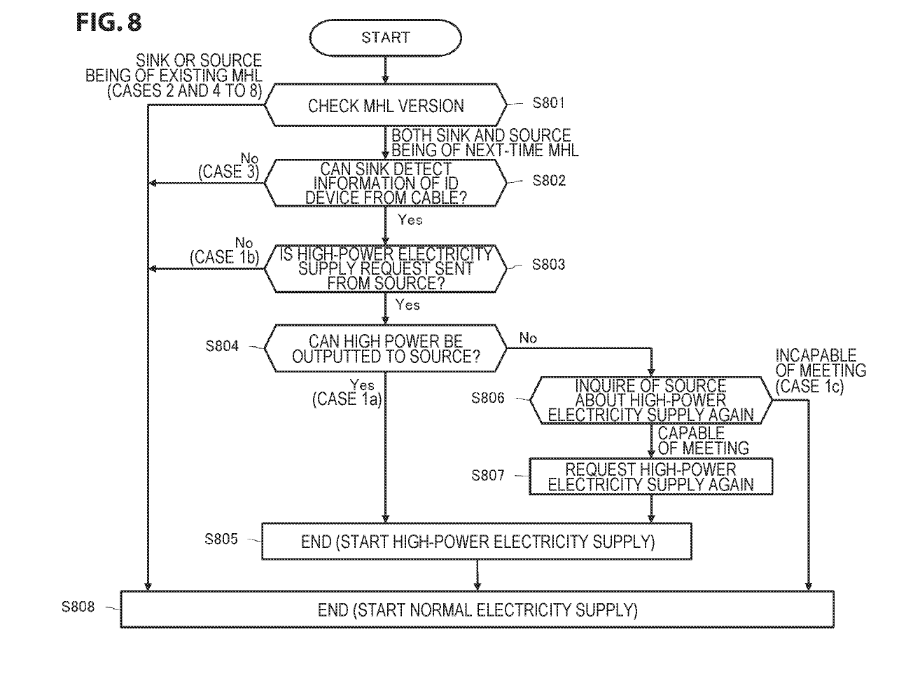

FIG. 8 shows a processing procedure for starting electric power supply from a sink device to a source device in a communication system in which the source device and the sink device are connected together via a cable, in a form of a flow chart. Here, it is supposed that each of the source device, the cable, and the sink device conforms to either the existing MHL standard or the next-time MHL standard.

First, the sink device performs, with the source device connected via the cable, the checking of the MHL version of the other side using a CBUS (step S801)

Here, the case where at least one of the sink device and the source device conforms to the existing MHL standard corresponds to cases 2 and 4 to 8 in Table 3; in these cases, the present processing routine is finished, and the sink device starts normal electricity supply to the source device (step S808).

On the other hand, in the case where both the sink device and the source device conform to the next-time MHL standard, subsequently the sink device attempts to read information of an ID device from the cable joined to the sink device (step S802).

Here, in the case where the sink device cannot read the information of the ID device from the cable (No of step S802), the sink device determines that the cable joined to itself at the present conforms to the existing MHL standard, and finishes the present processing routine; and the sink device starts normal electricity supply to the source device (step S808).

Note that the case where both the sink device and the source device conform to the next-time MHL standard but the cable conforms to the existing MHL standard corresponds to case 3 in Table 3. However, the sink device cannot read the information of the ID device also in the case where a cable conforming to the next-time MHL standard and having directivity is set in the opposite direction and is connected to the sink device (see FIG. 6); also in this case, the sink device determines that the cable joined to itself at the present conforms to the existing MHL standard, for the sake of convenience (No of step S802).

Further, in the case where the sink device has read the information of the ID device from the cable successfully (Yes of step S802), the sink device determines that the cable joined to itself at the present conforms to the next-time MHL standard, and on the basis of the information read from the ID device (a coded value, see Table 2), recognizes a rated current and a rated voltage that the cable can transmit.

The source device conforming to the next-time MHL standard can request high-power electricity supply to the sink device via the CBUS. The sink device checks whether or not a request of high-power electricity supply has been sent from the source device (step S803).

The case where the source device conforming to the next-time MHL standard does not request high-power electricity supply (No of step S803) corresponds to case 1b in Table 3; in this case, the present processing routine is finished, and the sink device starts normal electricity supply to the source device (step S808).

On the other hand, in the case where the source device conforming to the next-time MHL standard requests high-power electricity supply (Yes of step S803), the sink device checks whether the output of high power matched with the request of the source device is possible or not (step S804), and notifies the checking result to the source device via the CBUS.

If the output of the sink device is insufficient with respect to the request of high-power electricity supply from the source device, or if the request of high-power electricity supply exceeds the rated current or the rated voltage of the cable read from the ID device, the sink device cannot output high power matched with the request (No of step S804).

In this case, the sink device notifies the source device via the CBUS that high-power electricity supply is impossible. In response to this, the source device inquires into its own high-power electricity supply again, and checks whether or not to request high-power electricity supply again within the permissible ranges of the sink device and the cable (step S806).

For example, in a case where, while the amount of electricity supply requested by the source device is 3 A and 12 V, the rated current and the rated voltage of the cable are 3 A and 12 V, respectively, but the electricity supply capacity of the sink device is only 3 A and 9 V, the sink device notifies 3 A and 9 V, which are the upper limit of output, to the source device via the CBUS. On the basis of the sent upper limit values, the source device calculates again the value of high-power electricity supply to be requested, and checks whether or not to request high-power electricity supply to the sink device again.

In the case where the source device has decided to change the necessary amount of electricity supply and request high-power electricity supply again (Yes of step S806), the source device requests high-power electricity supply to the sink device via the CBUS again (step S807), and high-power electricity supply is started (step S805).

Further, in the case where the source device cannot meet the re-inquiry of high-power electricity supply from the sink device (No of step S806), the source device notifies that fact to the sink device via the CBUS. Then, the present processing routine is finished, and the sink device starts normal electricity supply to the source device (step S808).

For example, in a case where an electricity supply with upper limit values of output of 3 A and 9 V notified from the sink device is acceptable, the source device notifies that fact to the sink device via the CBUS, and the sink device starts a high-power electricity supply with 3 A and 9 V. Further, in a case where the source device does not match with the notified upper limit values of 3 A and 9 V (for example, in a case where the source device is not adapted to an electricity supply of 9 V), a normal electricity supply with 0.9 A and 5 V, which are less than or equal to the notified upper limit values, is started.

Further, in the case where high power matched with the request of the source device can be outputted (Yes of step S804), the sink device starts high-power electricity supply matched with the request from the source device (step S805).

For example, if, while the amount of electricity supply requested by the source device is 3 A and 12 V, the rating of the cable is 3 A and 12 V and also the electricity supply capacity of the sink device satisfies 3 A and 12 V, high-power electricity supply is started with 3 A and 12 V, which are matched with the request from the source device.

Note that, in the case where high-power electricity supply matched with the request of the source device cannot be received from the sink device (in the case where high-power electricity supply is performed with a reduced rating or in the case where (not high-power) normal electricity supply is performed), it is also supposed that a service matched with the user's expectation cannot be provided (for example, the source device performs power saving by restraining fast charging, reducing the processing speed, or reducing the output). Thus, in the case where high-power electricity supply matched with the request of the source device is not performed, it is preferable that an error display of high-power electricity supply being impossible be performed in the source device or the sink device so that the user is not misled. Examples of error displays for the case numbers shown in Table 3 are collectively shown in Table 4 below.

TABLE 4

| | Electricity supply | | |
|---|---|---|---|
| | Normal | High-power | Error display of high-power |
| | electricity | electricity | electricity supply being |
| Case | supply | supply | impossible |
| 1a | Possible | Possible | Unnecessary |
| 1b | Possible | Unnecessary | Unnecessary |
| 1c | Possible | Impossible | Source device or sink device |
| 2 | Possible | Impossible | Source device |
| 3 | Possible | Impossible | Source device or sink device |
| 4 | Possible | Impossible | Source device |
| 5 | Possible | Impossible | Unnecessary |
| 6 | Possible | Impossible | Unnecessary |
| 7 | Possible | Impossible | Unnecessary |
| 8 | Possible | Impossible | Unnecessary |

In the case where the source device conforms to the existing MHL standard or in the case where high-power electricity supply is unnecessary (cases 1b and 5 to 8 in Table 3), normal electricity supply is performed in all the combinations, and hence an error display is unnecessary.

Further, in the case where the source device requests high-power electricity supply but the sink device conforms to the existing MHL standard (cases 2 and 4 in Table 3), an error display is performed only in the source device.

Further, in the case where the source device and the sink device are adapted to high-power electricity supply and the cable alone is not adapted to high-power electricity supply (case 3 in Table 3), an error display showing that “this cable is not adapted to high-power electricity supply” or the like is performed in at least one of the source device and the sink device.

Further, in the case where all of the source device, the cable, and the sink device conform to the next-time MHL standard but the output of at least one of the cable and the sink device is insufficient (case 1c in Table 3), an error display in which the cause is identified may be performed in at least one of the source device and the sink device.

Further, in the case where all of the source device, the cable, and the sink device are adapted to high-power electricity supply (case 1a in Table 3), in the first place this is not an error, and an error display is unnecessary.

Note that the display section that performs the error display may be a display section such as a liquid crystal display included in the source device or the sink device, or may be a display device externally connected to the main body of the source device or the sink device.

By the communication system 1 according to the present embodiment (see FIG. 2 or FIG. 3), effects (1) to (4) described below can be expected.

### (1) Improvement of Commercial Value

In the existing MHL system, only a limited electric power supply can be performed, and a sufficient electricity supply cannot be performed to a large-capacity source device. In contrast, in the (next-time) communication system 1 according to the present embodiment, adaptation to electricity supply to a large-capacity source device, fast charging utilizing high-power electricity supply, etc. is possible.

### (2) Expansion of Compatible Models

By the communication system 1 according to the present embodiment, electricity supply between the main body and a display of a separate body-type model, which model has so far not employed an MHL standard because the amount of electric power supply has been insufficient, and electric power supply to a projector device are enabled. Thus, the spread of the next-time MHL standard to these devices is possible.

### (3) Improvement of Reliability

In the communication system 1 according to the present embodiment, the rating of the cable is found on the basis of information read from the ID device; therefore, an electric power more than or equal to the supply capacity does not flow through the cable, and quality problems such as smoke emission and fire catching due to an eddy current or an overvoltage can be avoided.

### (4) Improvement of Manipulability

In the communication system 1 according to the present embodiment, the setting and operation of an optimum electricity supply are performed automatically by simply making connection, without the user's consciousness of whether or not each of the source device, the sink device, and the cable is adapted to high-power electricity supply. Further, when the high-power electricity supply requested by the source device cannot be performed, an error display is performed in the source device or the sink device, and therefore the user can grasp the condition of the system easily.

### INDUSTRIAL APPLICABILITY

The foregoing thus describes the technology disclosed in this specification in detail and with reference to specific embodiments. However, it is obvious that persons skilled in the art may make modifications and substitutions to these embodiments without departing from the spirit of the technology disclosed in this specification.

In the present specification, the description is given with emphasis on embodiments in which a technology disclosed in the present specification is applied to a communication system in which devices are connected together by a communication interface based on MHL; but the spirit of the technology disclosed in the present specification is not limited to these. The technology disclosed in the present specification can be similarly applied to communication systems based on various communication interface standards that transmit video information and audio information and perform electric power supply.

Essentially, the technology disclosed in this specification has been described by way of example, and the stated content of this specification should not be interpreted as being limiting. The spirit of the technology disclosed in this specification should be determined in consideration of the claims.

Additionally, the present technology may also be configured as below.

(1)

An information processing apparatus including:

a communication section configured to communicate with another device via a cable;

a detection section configured to detect information regarding electricity supply of the cable; and

a control section configured to control electric power supply to the other device via the cable on a basis of a result of detection by the detection section.

(2)

The information processing apparatus according to (1),

in which the detection section detects the information regarding the electricity supply of the cable from an ID device included in the cable.

(3)

The information processing apparatus according to (2),

in which the detection section detects information of the ID device via a cable detection signal line that is DC-cut.

(4)

The information processing apparatus according to (2),

in which the communication section communicates with the other device via the cable conforming to a prescribed communication interface standard, and

the detection section detects information of the ID device via a cable detection signal line allocated to a reserved pin in the prescribed communication interface standard.

(5)

The information processing apparatus according to (1),

in which the control section controls electric power supply to the other device via the cable in accordance with an electricity supply request from the other device.

(6)

The information processing apparatus according to (5),

in which the control section determines whether or not electric power requested by the other device is able to be transmitted with a rated current or a rated voltage of the cable detected by the detection section.

(7)

The information processing apparatus according to (5),

in which the control section notifies the other device that electric power requested by the other device is unable to be transmitted via the cable.

(8)

The information processing apparatus according to (5),

in which the control section notifies the other device that electric power requested by the other device is unable to be outputted from the information processing apparatus.

(9)

The information processing apparatus according to (7) or (8),

in which the control section displays, on a display section, a fact that the electric power requested by the other device is unable to be supplied.

(10)

The information processing apparatus according to (1),

in which the communication section communicates with the other device via the cable conforming to a prescribed communication interface standard, and

the control section controls electric power supply to the other device in accordance with a version of the prescribed communication interface standard that the other device and the cable conform to.

(11)

The information processing apparatus according to (10),

in which the control section notifies the other device that electric power requested by the other device is unable to be transmitted with the version that the cable conforms to.

(12)

The information processing apparatus according to (4) or (10),

in which the prescribed communication interface standard is a superMHL standard.

(13)

A method for controlling an information processing apparatus,

the information processing apparatus being configured to communicate with another device via a cable,

the method including:

a detection step of detecting information regarding electricity supply of the cable; and

a control step of controlling electric power supply to the other device via the cable on a basis of a result of detection in the detection step.

(14)

A cable including:

a first connection section to be connected to a first device configured to transmit information;

a second connection section to be connected to a second device configured to receive the information; and

an ID device capable of reading, from the second connection section, information regarding electricity supply.

(15)

The cable according to (14),

in which the ID device is capable of performing reading from the second connection section via a cable detection signal line that is DC-cut.

(16)

The cable according to (14),

in which the second connection section is to be connected to the second device conforming to a prescribed communication interface standard, and

the cable signal line is allocated to a reserved pin in the prescribed communication interface standard.

(17)

The cable according to (14),

in which the ID device retains information regarding a rated current or a rated voltage transmittable with the cable.

(18)

The cable according to (14),

in which the ID device retains a coded value indicating a combination of a rated current and a rated voltage transmittable with the cable.

(19)

The cable according to (14), further including:

a second ID device capable of reading, from the first connection section, the information regarding electricity supply.

(20)

The cable according to (16),

in which the prescribed communication interface standard is a superMHL standard.

### REFERENCE SIGNS LIST

1 communication system
10 source device
11 transmission section
12 register section
20 sink device
21 reception section
22 register section
23 EDID ROM
30 cable
31-1 to 31-N TMDS channel
32 CBUS
33 VBUS
34, 34′ ID device
35, 35′ cable detection signal line

1. An information processing apparatus comprising:
a communication section configured to communicate with another device via a cable;
a detection section configured to detect information regarding electricity supply of the cable; and
a control section configured to control electric power supply to the other device via the cable on a basis of a result of detection by the detection section.

2. The information processing apparatus according to claim 1,
wherein the detection section detects the information regarding the electricity supply of the cable from an ID device included in the cable.

3. The information processing apparatus according to claim 2,
wherein the detection section detects information of the ID device via a cable detection signal line that is DC-cut.

4. The information processing apparatus according to claim 2,
wherein the communication section communicates with the other device via the cable conforming to a prescribed communication interface standard, and
the detection section detects information of the ID device via a cable detection signal line allocated to a reserved pin in the prescribed communication interface standard.

5. The information processing apparatus according to claim 1,
wherein the control section controls electric power supply to the other device via the cable in accordance with an electricity supply request from the other device.

6. The information processing apparatus according to claim 5,
wherein the control section determines whether or not electric power requested by the other device is able to be transmitted with a rated current or a rated voltage of the cable detected by the detection section.

7. The information processing apparatus according to claim 5,
wherein the control section notifies the other device that electric power requested by the other device is unable to be transmitted via the cable.

8. The information processing apparatus according to claim 5,
wherein the control section notifies the other device that electric power requested by the other device is unable to be outputted from the information processing apparatus.

9. The information processing apparatus according to claim 7,
wherein the control section displays, on a display section, a fact that the electric power requested by the other device is unable to be supplied.

10. The information processing apparatus according to claim 1,
wherein the communication section communicates with the other device via the cable conforming to a prescribed communication interface standard, and
the control section controls electric power supply to the other device in accordance with a version of the prescribed communication interface standard that the other device and the cable conform to.

11. The information processing apparatus according to claim 10,
wherein the control section notifies the other device that electric power requested by the other device is unable to be transmitted with the version that the cable conforms to.

12. The information processing apparatus according to claim 4,
wherein the prescribed communication interface standard is a superMHL standard.

13. A method for controlling an information processing apparatus,
the information processing apparatus being configured to communicate with another device via a cable,
the method comprising:
a detection step of detecting information regarding electricity supply of the cable; and
a control step of controlling electric power supply to the other device via the cable on a basis of a result of detection in the detection step.

14. A cable comprising:
a first connection section to be connected to a first device configured to transmit information;
a second connection section to be connected to a second device configured to receive the information; and
an ID device capable of reading, from the second connection section, information regarding electricity supply.

15. The cable according to claim 14,
wherein the ID device is capable of performing reading from the second connection section via a cable detection signal line that is DC-cut.

16. The cable according to claim 14,
wherein the second connection section is to be connected to the second device conforming to a prescribed communication interface standard, and
the cable signal line is allocated to a reserved pin in the prescribed communication interface standard.

17. The cable according to claim 14,
wherein the ID device retains information regarding a rated current or a rated voltage transmittable with the cable.

18. The cable according to claim 14,
wherein the ID device retains a coded value indicating a combination of a rated current and a rated voltage transmittable with the cable.

19. The cable according to claim 14, further comprising:
a second ID device capable of reading, from the first connection section, the information regarding electricity supply.

20. The cable according to claim 16,
wherein the prescribed communication interface standard is a superMHL standard.
